(19) United States
(12) Patent Application Publication
(10) Pub. No.: US 2012/0202186 A1
(43) Pub. Date: Aug. 9, 2012

(54) INTERACTIVE COMMUNITY NETWORK FOR YOUTH ATHLETICS

(75) Inventors: Christopher C. Flood, Randolph, NJ (US); Christopher Michaels, Mendham, NJ (US); Nicholas L. Molinaro, Mendham, NJ (US)

(73) Assignee: SPORTSYNERGY, LLC, Mendham, NJ (US)

(21) Appl. No.: 13/364,613

(22) Filed: Feb. 2, 2012

Related U.S. Application Data
(60) Provisional application No. 61/440,466, filed on Feb. 8, 2011.

(51) Int. Cl. G09B 7/00

(52) U.S. Cl. 434/362

(57) ABSTRACT

An interactive community network for youth athletics system, comprising a processor and memory comprising program instructions. The program instructions are executable by the processor to store a series of educational messages, each education message being associated with at least one youth athletics core development factor and a threshold range of aggregated numerical scores. Questions are issued, each question corresponding to a youth athletics core development factor. Selectable answers to each question are provided, each selectable answer corresponding to a numerical score. A series of user answers to the questions are received. The numerical scores by youth athletics core development factor are aggregated to create the aggregated numerical score for each corresponding youth athletics core development factor. One of the series of specific educational messages is selected for display when the aggregated numerical score for a corresponding youth athletics core development factor falls within the threshold range.

### CROSS-REFERENCE TO RELATED APPLICATION

This application claims the benefit of U.S. Provisional Application No. 61/440,466, filed Feb. 8, 2011, the entire disclosure of which is incorporated herein by reference.

### BACKGROUND

1. Field

This disclosure relates generally to management involving youth sports and their administrative organizations, and more particularly, organizational management.

2. Background

Youth sports today suffer from a number of deficiencies. The culture of youth sports has become increasingly competitive, specialized and professionalized. This has created a highly pressured environment not only for athletes and parents, but also for the sports leagues and coaches. Unrealistic performance goals, no goals, or the inability to create attainable goals may occur, pressuring parents and coaches to maintain detrimentally high standards for the athletes. Coaches are in turn expected to produce impossible results, and are often unjustly criticized and dismissed for a failure to produce those results. This is damaging to youth sport participation, causing a majority of young athletes to quit youth sports entirely because of the resulting stress, pressure and decline in interest for the sport. As a result, the sports leagues suffer from high turnover rates in both athletes and coaches. Thus, a detrimentally high-pressure environment persists in youth sports today, which is damaging to parents, athletes, coaches and sports leagues.

### BRIEF SUMMARY

In one aspect of this disclosure, a computer-implemented system for implementing an interactive community network for youth athletics is disclosed, comprising at least one programmable processor and computer storage accessible by the processor. The programmable processor is connected to the computer storage to receive information from the computer storage. The computer storage comprises a series of educational messages, each educational message being associated with at least one youth athletics core development factor and a threshold range of numerical scores. The computer storage also includes a series of questions about an athlete, each question corresponding to a youth athletics core development factor. The computer storage also includes selectable answers to each question, each selectable answer corresponding to a numerical score. The computer storage also includes program instructions which, when executed, cause the programmable processor to issue the series of questions about the athlete to a user, receive an answer selection for each question from the user, aggregate the numerical scores according to each youth athletics core development factor, and generate a personalized educational message for display based on a result of the aggregation by selecting at least one of the educational messages in the series of educational messages when the aggregated numerical score for a corresponding youth athletics core development factor associated with the at least one of the educational messages falls within the threshold range associated with the at least one of the educational messages.

In another aspect of this disclosure, a computer-implemented method for implementing an interactive community network for youth athletics is disclosed, the method comprising maintaining, in computer storage, a series of educational messages, each educational message being associated with at least one youth athletics core development factor and a threshold range of numerical scores. A series of questions about an athlete are issued to a user, using a computer processor, each question corresponding to a youth athletics core development factor. Selectable answers to each question are provided, each selectable answer corresponding to a numerical score and an answer selection for each question is received from the user. The numerical scores are aggregated, using the computer processor, according to each youth athletics core development factor. A personalized educational message is generated for display based on a result of the aggregation by selecting at least one educational message in the series of educational messages when the aggregated numerical score for a corresponding youth athletics core development factor associated with the at least one educational message falls within the threshold range associated with the at least one educational message.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is a high level representation of an interactive community network for youth athletics system;

FIG. 2 is a flow chart representing a sequence of steps for implementing an illustrative interactive community network for youth athletics;

FIG. 3 is a flow chart representing a continuing sequence of steps for implementing an illustrative interactive community network for youth athletics;

FIG. 4 is a flow chart representing a continuing sequence of steps for implementing an illustrative interactive community network for youth athletics;

FIG. 5 is a flow chart representing a continuing sequence of steps for implementing an illustrative interactive community network for youth athletics; and

FIG. 6 is a flow chart representing a continuing sequence of steps for implementing an illustrative interactive community network for youth athletics.

### DETAILED DESCRIPTION

This application discloses an interactive community network system and method for youth athletics. The interactive community network system and method for youth athletics may help athletes advance personal and athletic development on and off the field by aligning the athletic development process with the parents, coaches and sports leagues that administer youth sports. The system and method are unique in that the entire process may be personalized to the athlete's age, experience, sport, league, etc. The system and method may also enable the creation of a process through which all participants may synergistically contribute towards the athlete's development. The process may include a number of steps, such as goal selection, instruction, and periodic review to provide feedback to the athlete and other interested parties. Personalized information may then be provided to guide athletic improvement for each of these steps. Associating these processes across participants, such as coaches, parents, and athletes may enable unique seasonal interactions that facilitate a more cooperative athletic environment. Finally, the system and method may provide management tools specific to elements such as (but not limited to) the process, products and services, thereby ensuring participant accountability. These tools may enable oversight by coaches on a team-level, and by program managers on a league-level, thereby ensuring personal accountability and tracking at multiple organizational levels.

Therefore, athletes may have healthier experiences, increasing the rate of reenrollment. The creation of new communication channels and educational material may deter unhealthy situations, both on and off the athletic field. The support provided by the system and method may also enable recruitment, training and retention of excellent coaches, discouraging the high amount of coach turnover and player drop out rate prevalent in youth athletic leagues. Finally, the web-based toolset and content may encourage increased positive collective involvement and accountability throughout the season, which may create a cooperative and optimal performing environment through personalized guidance specifically tailored to each athlete's sport, league, age, ability and goals.

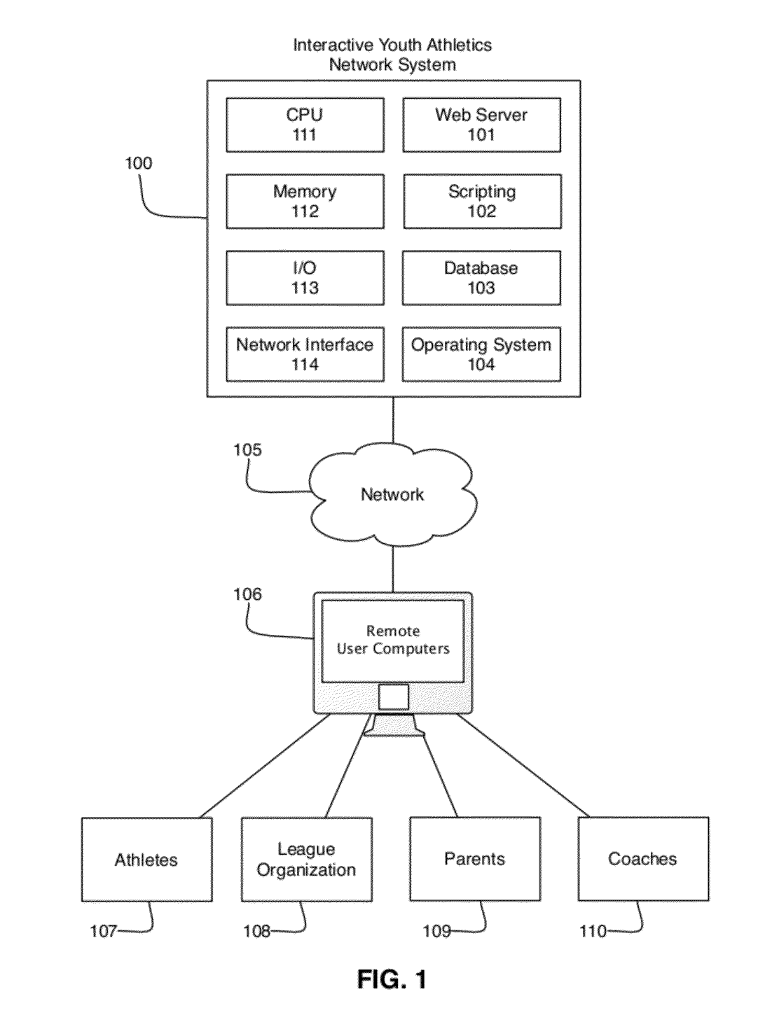

FIG. 1 is a high level representation of an interactive community network for youth athletics system 100. The interactive community network for youth athletics system 100 may be implemented as a system supporting a dynamic web page through which parents, coaches, athletes and organizers interact. The interactive community network for youth athletics 100 may be implemented utilizing one or more computing systems of varying configuration. For instance, the components may be combined within a single computing system. Alternatively, operating components may be spread among multiple computer systems. In either case, the computer system (or systems) preferably includes computing components for executing computer program instructions and processes. These components may include a central processing unit (CPU) 111, memory 112, input/output (I/O) devices 113, and a network interface 114.

The CPU 111 processes and executes computer program instructions. Random access memory (RAM) 112 and/or fast access cache memory preferably provides fast data supply to CPU 111. Long-term storage may be provided as a more permanent form of computer memory, and may be, for example, a hard disk, optical disk, flash memory, solid-state memory, tape, or any other type of memory. The database may exist at an onsite facility (if one exists) or, it may be implemented via “cloud-computing” enabled data storage and retrieval. The network interface device 114 may provide the computing system with access to a Network 105, which may be a wireless or wired connection. Network 105 may be, for example, the Internet, a corporate intranet, or any other computer network through which the computing system may connect to or otherwise communicate with other computers.

The interactive athletics community for youth system 100 may also include a web server 101, scripting component 102, database 103 and operating system 104. These components may enable creation of dynamic web content for athletes 107, league organizations 108, parents 109, coaches 110, and any other entities that may utilize the interactive community network for youth athletics system 100. Web server 101 may be configured to service incoming requests from users. Requests related to dynamic web pages may be forwarded to the scripting component 102, which may process the scripts to create the dynamic web page. These same scripts may enable retrieval and storage of information in database 103. Data associated with implementation of the interactive community network for youth athletics system 100, such as user information, league information, medical data, etc. may be stored in (and retrieved from) database 103.

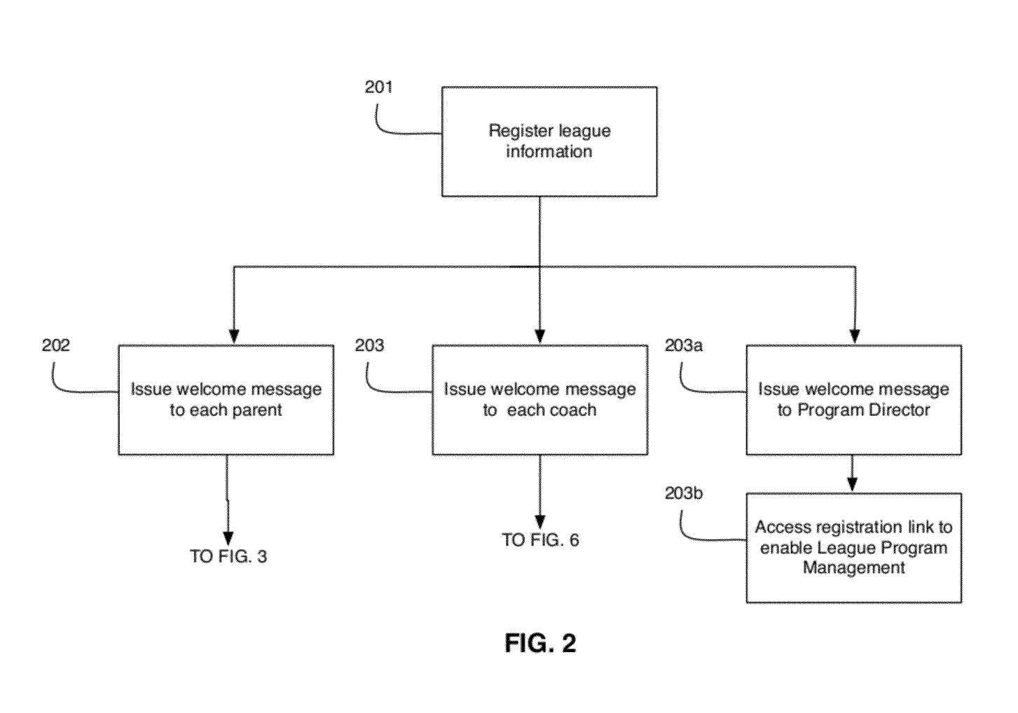

FIG. 2 is a flow chart representing a sequence of steps for implementing an illustrative interactive community network for youth athletics system 100. In step 201, a youth athletics sports league 108 may register with the interactive community network for youth athletics system 100. Registration may be accomplished via transmission of relevant registration data from a remote computer 106. During registration, the league organization 108 user may forward pertinent information to the interactive community network for youth athletics system 100, including, for example, parent and coach roster information. An administrator of the interactive community network for youth athletics system 100 may then navigate to a dynamic web page hosted by the interactive community network for youth athletics system 100, either locally or through network 105 for the purposes of registering the athletic youth league. Required registration information may be input into fields on the dynamic web page. This information may include basic information such as the name of the league, relevant sports activities, a preliminary schedule of the season, a listing of league organizers, known information on coaches, parents, athletes such as names, addresses, e-mail addresses, home/mobile phone numbers, etc. Once completed, the registration information may then be encapsulated and transmitted over network 105 to the interactive youth athletics network system 100, where it may be parsed and stored in database 103.

Once the athletic youth league has been registered with the interactive community network for youth athletics system 100, the interactive community network for youth athletics system 100 may then begin active registration of coaches 110, parents 109 and athletes 107. Therefore, in steps 202 and 203, welcome messages may be issued to all parents 109 and coaches 110. These welcome messages may be sent electronically from the interactive community network for youth athletics system 100 over network 105. For example, welcome messages may be sent as e-mails to the e-mail addresses (as obtained from registration of the league) of parents 109 and coaches 110. Alternatively, welcome messages may be sent by telephone, text message, letter or any other suitable or desirable means. The welcome messages may provide a basic introduction to the interactive community network for youth athletics system 100, and direct parents 109 and coaches 110 to enrollment pages for the interactive community network for youth athletics system 100.

In step 203a, a welcome message may also be sent to the Program Director for the league organization 108. In step 203b, the Program Director may access a registration link included with the welcome message. As with the parent 109 and coach 110 enrollment, the registration link preferably directs the Program Director to a registration web page. Completion of registration may then grant the Program Director access to a League Overview Tool (described further below), with which he may then manage the system and process for the entire league organization 108.

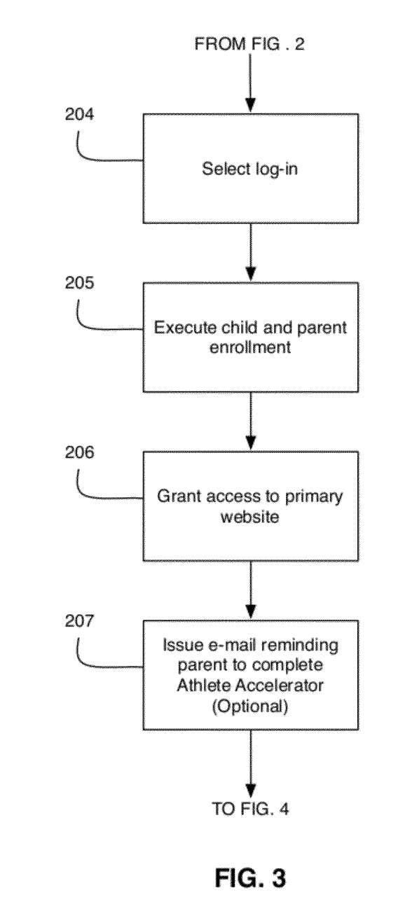

FIG. 3 is a flow chart representing a continuing sequence of steps for implementing an illustrative interactive community network for youth athletics system 100. In step 204, the parent 109 may execute creation of a user account, including, for example, a selected user name and password that may govern access and use of the interactive community network for youth athletics system 100. Once the parent 109 has completed entering the information necessary to create a basic account, the information may be encapsulated and transmitted over network 105 to the interactive community network for youth athletics system 100, where it may then be stored in database 103.

In step 205, parent and child enrollment may be executed. The parent 109 may be directed to a dynamic web page hosted by the interactive community network for youth athletics system 100, where a questionnaire with fillable fields is presented. Parent 109 may enter the desired and/or required information remotely over network 105 using a remote user computer 106 into the fillable fields, which correspond to information necessary to complete parent enrollment with the interactive community network for youth athletics system 100. This information may include the child's name, nickname, date of birth, gender, the names of the parents, designation of a primary contact, one or more phone numbers, e-mail addresses and third party emergency contact information. The information may also include secondary questions, such as the child's student status, involvement in special educational programs, the number of children in the family, and the birth order of the child. Finally, the information may include questions regarding the sport activity to be registered, the type of sport, the amount of experience the child has had with the sport, knowledge of the sport rules, the priority sport if the child is participating in more than one sport, and the amount of experience the child has had with sports in general. Optional text fields may be provided for the parent 109 to enter, for example, the primary goal for the season, or to voice any special concerns or issues. A survey may be issued to obtain feedback on the enrollment process. Once completed, the information may be encapsulated and transmitted over network 105 to the interactive community network for youth athletics system 100, where it may then be stored in database 103.

In step 206, the parent 109 may be granted access to the interactive community network for youth athletics system 100 primary website. A confirmation may be displayed to the parent 109, including a reminder for the parent 109 to complete the “Athlete Accelerator.” If the parent 109 (and/or athlete 107) fails to complete the “Athlete Accelerator,” then in step 207, a notification may be automatically generated and sent to the parent 109 (and/or athlete 107) to remind them to complete it. Questions may be answered solely by parents 109 when athlete 107 is too young to complete the “Athlete Accelerator.” In circumstances where athletes 107 are of sufficient age, however, both parents 109 and athletes 107 may work together to complete the “Athlete Accelerator,” thereby creating a synergistic foundation between athlete 107 and parent 109 for the development of athlete 107 throughout the season.

The “Athlete Accelerator” may comprise three distinct segments. The first segment may present assessment questions regarding the core tenets of athlete performance, sports satisfaction and fulfillment. Questions may be directed to determine the disposition of the parent 109 and athlete 107 towards core development factors and sport specific factors. Core development factors may include (but are not limited to) goal setting, temperament, emotional management (such as management of anxiety or anger), attention, reset and self-belief. Sport specific factors may include (but are not limited to) physical and mental actions or attributes of the athlete 107 that contribute to success in the athlete's chosen sport, as well as the athlete's age, gender and position associated with the athlete's chosen sport. In the second segment, guided educational material and other useful aids may be dynamically generated from (at least in part) information obtained during this initial “Athlete Accelerator” segment. Finally, in the third segment, athletes 107 and parents 109 may select (and be assigned) specific achievement goals for the upcoming season.

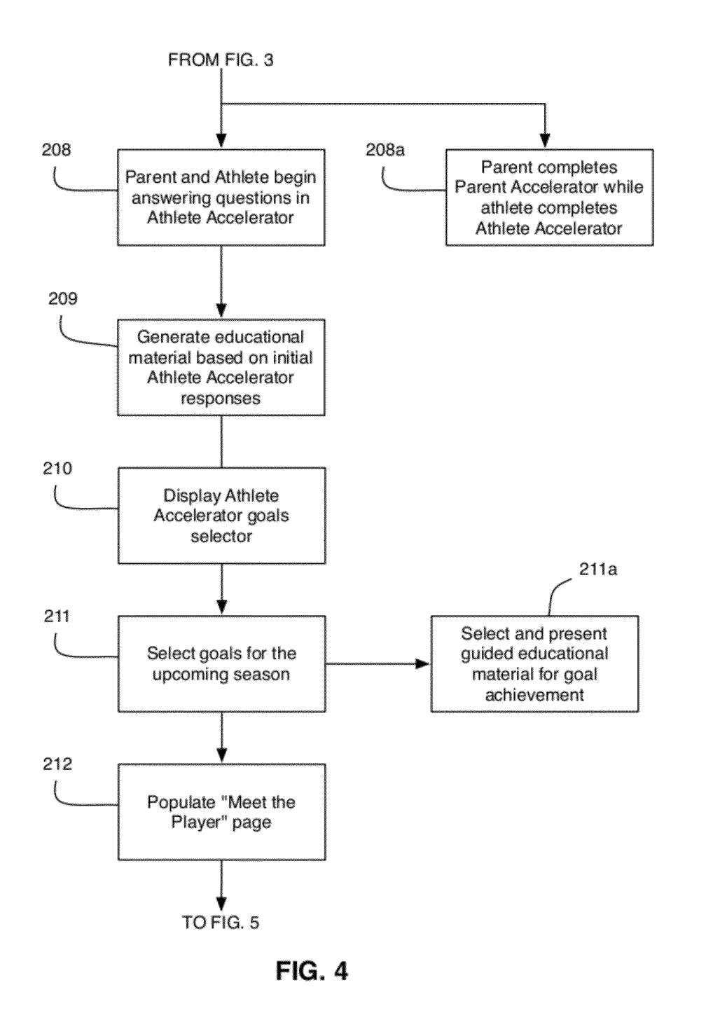

FIG. 4 is a flow chart representing a continuing sequence of steps for implementing an illustrative interactive community network for youth athletics 100. In step 208, the interactive community network for youth athletics system 100 may execute the “Athlete Accelerator” for the parent 109 and athlete 107. As described above, the first segment of the “Athlete Accelerator” may include questions designed to determine the disposition of athlete 107 and parent 109 towards core developmental factors and sport specific factors. Each question preferably targets at least one of either the core developmental factors or sport specific factors.

The questions presented in the “Athlete Accelerator” may be answered via selection of responses off a scale. Preferably, the scale is the five grade Likert Scale, with the first grade corresponding to an opinion of “strong agreement” and the fifth grade corresponding to an opinion of “strong disagreement.” Each grade may then be associated with a number. Grades may also be accompanied by a sample opinion that may make the relative “strength” of agreement or disagreement with the question more readily apparent.

In step 209, the interactive community network for youth athletics system 100 may utilize the responses to algorithmically generate personalized educational material for the parent 109 and athlete 107. As the parent 109 and athlete 107 answer questions, numbers may be aggregated for each core development factor and each sport specific factor, using the core development factor or sport specific factor associated with each question. Once the parent 109 has completed the survey, an aggregate score total may be compiled for each core development factor and each sport specific factor. Based on a predefined threshold range of results for each core development factor and each sport specific factor, pre-defined guided educational material may be selected for presentation. Other factors may also be included in selection of the guided educational material, such as the age of the athlete 107, the sport in which the athlete 107 is participating in, specific traits of the League Organization 108, and any other factor beneficial to creating a targeted, personalized guide for the individual in question. The pre-defined educational material may take a variety of formats depending on the need and goal. For example, it may take the form of text, when simple one-way counseling or guidance is all that is required. Alternatively, pictures, animations, or even full multimedia presentations may be utilized according to need. Therefore, in step 209, guided educational material may be provided to the parent 109 upon completion of the first “Athlete Accelerator” segment based on the answers the parent 109 has provided in response to the questionnaire. The educational material may be compiled into a presentable format, and then sent over network 105 to the parent 109 for display on user computer 106. In this manner, a personalized educational message may be generated for display based on a result of the aggregation by selecting one or more of the pre-defined education materials when the aggregated numerical score for a corresponding core development factor or sport specific factor associated with the educational material falls within the threshold range associated with the educational material.

The “Athlete Accelerator” may also include an “Athlete Medical Questionnaire.” The “Athlete Medical Questionnaire” may algorithmically aid in a determination of whether or not the athlete 107 is eligible and/or ready for a particular sport depending on the answers provided to the “Athlete Medical Questionnaire.” The “Athlete Medical Questionnaire” may query the parent 109 on a wide range of current or historical medical conditions of the athlete 107.

Once the parent 109 has completed entering responses to the questions, the interactive community network for youth athletics system 100 may determine whether the parent 109 has answered affirmatively with respect to the existence of one or more medical conditions. If the parent 109 has answered affirmatively, the interactive community network for youth athletics system 100 may algorithmically select guidance material for presentation based on the medical condition, the sport or sports with which the athlete 107 is enrolled, the age of the athlete 107, etc. The guidance material may, as above, take the form of text, visual aids, multimedia presentation, etc., and generally provide guidance to parent 109 and athlete 107 on how to deal with the medical condition while participating in the sport activity or activities.

The existence of one or more of these conditions (both singly and/or in combination) may also enable interactive community network for youth athletics system 100 to algorithmically aid a determination of whether the athlete 107 is eligible to play the sport(s) to which he or she is enrolled in. If the parent responds negatively to the existence of all medical conditions, then the parent is preferably directed to the main web page for the interactive community network for youth athletics system 100. This may be enabled in a variety of ways. For example, a hyperlink directing the parent 109 to the main website may be presented to the parent 109 upon completion of the “Athlete Medical Questionnaire.” Alternatively, a hyperlink may be forwarded to the e-mail address of parent 109 upon completion of the “Athlete Medical Questionnaire.” Any suitable method may be used as appropriate.

If the parent 109 answered affirmatively to the existence any medical condition, the interactive community network for youth athletics system 100 may require the parent 109 to elaborate on the medical condition. A comment field may be displayed, allowing a parent 109 to further describe a confirmed medical condition. Alternatively, in situations where simple “yes” and “no” answers are sufficient to explain the confirmed medical condition for the purposes of aiding in a determination as to whether the athlete 107 is eligible to participate, secondary questions may be presented to the parent 109 instead.

Other factors may be utilized to aid in a determination of whether an athlete 107 is eligible to participate in a sport. For example, the age, maturity, physique and other related information may be utilized as appropriate. For example, the age, maturity and physical strength of an athlete 107 of a kindergarten to second grade age level may be considered in determining whether the athlete 107 should be allowed to partake in little league baseball. These factors may be summarized in a Player Readiness Assessment, which may be used to aid in making a determination of sports participation readiness.

In step 210, an “Athlete Accelerator Goals Selector” may be displayed to parent 109. The “Goals Selector” may correspond to the third segment of the “Athlete Accelerator,” allowing an athlete 107 and parent 109 to select goals for the season. Generally, a variety of goals may be set for athlete 107 for the season. Goals may be divided into distinct goal categories. Preferably, the goals utilized may include sport-specific goals, core development goals and team goals. The sport-specific goals may include a player's physical and mental abilities that drive performance in a sport. For example, a sport-specific goal may be improving the performance of catching a ball with a dominant hand such that the athlete 107 can perform the action successfully 80% of the time. A core-development goal may include internalized goals for the athlete 107, such as strengthening confidence, self-belief, emotional management, motivation and mental control. Finally, team-goals may be directed towards improving the performance of athlete 107 within a team environment by increasing an understanding of team strategy, developing better situational awareness, and improving on inter-player cooperation. Therefore, in step 211, goals may be selected. Preferably, one sport-specific goal and one core-development goal are selected by athlete 107 and parent 109. Team goals may be assigned by coach 110 or the Program Director, so that all members of the team may simultaneously work towards common team goals.

In step 211a, educational material may be selected and presented for the achievement of the goals selected in the previous step. As above, educational material may be algorithmically selected based on a variety of factors, including information obtained during any of the previous steps. The educational material may therefore be specific to a variety of factors, including age, sex, medical condition, sport, league and goal(s). The educational material may also take the form of text, pictorial instruction, audio instruction or even multimedia, depending on need. For example, guided educational material helping an athlete 107 improve the performance of catching a ball with a dominant hand (as described above) may be more effective as a narrated video demonstrating and narrating the proper form and technique for the action, compared to a simple text-based instruction. Furthermore, the guided educational material may break the goal down into component steps, allowing each component step to be focused on and graded individually (as described further below). For example, the act of catching a ball may include the proper stance for receiving the ball, maintaining appropriate line-of-sight with the ball, how to receive it when it makes contact with the glove, etc. The goal-oriented educational material may be accessible at any time throughout the season through the interactive community network for youth athletics system 100.

Once the “Athlete Accelerator” is completed, then in step 212, a “Meet the Player” web page on the interactive community network for youth athletics system 100 may be populated with information received from registration, the “Athlete Accelerator,” the “Athlete Medical Questionnaire” and the “Goals Selector.” The “Meet the Player” page may then be made available for display to, for example, parents 109, athletes 107 and coaches 110.

In an alternative embodiment, parents 109 may be asked to complete an individual “Parent Accelerator,” instead of completing the “Athlete Accelerator” alongside athletes 107. This may be useful in situations where the athlete 107 is of sufficient age and maturity to perform self-evaluation with respect to their progress without needing the aid of parent 109. Therefore, in step 208a, parent 109 may complete the “Parent Accelerator” while the athlete 107 completes the “Athlete Accelerator.” The “Parent Accelerator” may significantly resemble the “Athlete Accelerator” in structure. Therefore, the “Parent Accelerator” may also be divided into three primary segments.

In the first segment, the “Parent Accelerator” may query parent 109 on athletic core development factors and sport specific factors. These questions may be tailored to determine the parental disposition of parent 109 toward these factors for athlete 107, rather than being a direct assessment of the disposition of athlete 107, as it is in the “Athlete Accelerator.” Similarly, in the second segment, personalized guidance material may then be algorithmically selected and presented to the parent 109 based on the answers provided in the previous segment. The personalized guidance material may be directed towards helping the parent 109 develop better methods to aid athlete 107 with respect to core development factors and sport specific factors. The third segment may include parental goal selection for the season. Parental goals may correlate to the goals of athlete 107, creating a cooperative platform to help parents 109 improve the techniques, methods, and knowledge base with which parent 109 may aid in the development of athlete 107 from the standpoint of a parental role. As with the “Athlete Accelerator,” the parent 109 may be required to complete “Parent Debriefing Forms” periodically throughout the season to gauge self-development with respect to the selected parental goals. Information received from the “Athlete Accelerator” completed by athlete 107 may be utilized to further specialize the “Parent Accelerator” process and results for parent 109.

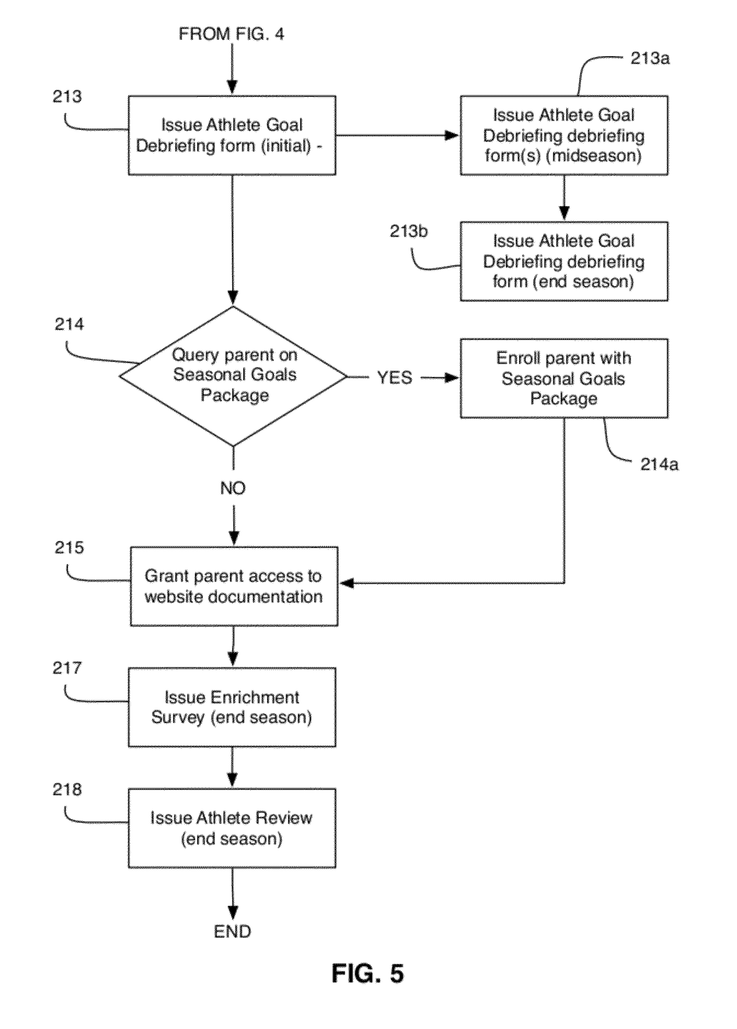

FIG. 5 is a flow chart representing a continuing sequence of steps for implementing an illustrative interactive community network for youth athletics system 100. In step 213, an “Athlete Goal Debriefing Form” may be issued by the interactive community network for youth athletics system 100 to parents 109. This initial “Athlete Goal Debriefing Form” may be generated from the information obtained during the “Athlete Accelerator,” and include a list of all selected goals for the upcoming season, and a break down of those goals into their respective subcomponents. For example, the form may include the above-described sport-specific goal of catching a ball with the dominant hand successfully 80% of the time. A time component may be added to the goal, indicating that the athlete 107 and parent 109 expect the athlete 107 to have achieved this goal by the selected deadline. By summarizing the selected goals and establishing the timeline in which the goals are to be achieved, parents 109 and athletes 107 may better develop synergistic plans directed towards achieving the selected goals.

In step 213a, at least one mid-season “Athlete Goal Debriefing Form” may be issued by the interactive community network for youth athletics system 100 to parents 109. The “Athlete Goal Debriefing Form” may possess substantially the same format as the initial “Athlete Goal Debriefing Form.” On the “Goal Debriefing” form, athletes 107 and parents 109 may enter information as to how the athlete 107 has progressed with respect to the selected sport-specific goal, core development goal and team goals. Each category may include sub-fields that allow parents 109 to enter additional feedback information on the goal attainment process, the performance of the athlete 107 during the process, and the overall outcome. Finally, a sliding scale may be provided, allowing a parent 109 and athlete 107 to rate the overall progress of athlete 107 on a scale from, for example, one to ten. Therefore, progress towards each goal and each goal sub-component may now be listed in the “Athlete Goal Debriefing Form.” This may aid parents 109 and athletes 107 in determining the progress the athlete 107 has made thus far in the season, highlighting weak areas for improvement, while maintaining progress in stronger areas, thereby allowing both parents 109 and athletes 107 to make more effective use of the remaining time in the season. Multiple mid-season “Athlete Goal Debriefing Forms” may be issued during the course of the season, according to need and desire.

In step 213b, an end-season “Athlete Goal Debriefing Form” may be issued by the interactive community network for youth athletics system 100 to parents 109. The end-season “Athlete Goal Debriefing Form” may summarize the same information as the initial and mid-season “Athlete Goal Debriefing Form,” except it may contain finalized information and summing the goals of athlete 107 for the entire season.

In step 214, the interactive community network for youth athletics system 100 may query parent 109 on enrollment in a “Seasonal Goals Package.” An automated “Seasonal Goals Package” may also be included in the interactive community network for youth athletics system 100. The “Seasonal Goals Package” may be professionally structured to work with individual athletes 107. Baseline testing may be performed and recorded via the interactive community network for youth athletics system 100. Strengths and weaknesses of the athlete 107 may be identified via the baseline testing, in conjunction with the information determined from the “Athlete Accelerator.” Individualized counseling may therefore be provided to the athlete 107 in tandem with the interactive community network for youth athletics system 100 to improve his or her performance by instructing the athlete 107 on how to apply specific learning techniques based on a schedule of attainable goals. If the parent 109 chooses to enroll, then in step 214a, the parent 109 may be registered with the “Seasonal Goals Package” service and then system may progress to step 215. If the parent 109 declines enrollment, then the system may progress to step 215.

In step 215, parent 109 may finally be granted access to the interactive community network for youth athletics system 100 website documentation having completed all enrollment steps. This documentation may include the “Parent Guide,” “Meet the Player,” “Athlete Goal Debriefing Form,” “Meet the Coach,” “Team Roster,” “Team Schedule,” and “League Information” web pages. These pages may be may be dynamically generated from information received earlier by the interactive community network for youth athletics system 100, as available. The “Team Roster” web page may list the players affiliated with the athlete 107 child, and provide links to their basic information. The “Team Schedule” web page may list upcoming events for the season, such as practices and games against other teams. The “League Information” web page may list basic information about League Organization 108.

The “Parent Guide” may include customized information specifically tailored for the athlete 107 and parent 109. In particular, the “Parent Guide” may be generated based on information such as the specific sports league in which athlete 107 is enrolled, the age of athlete 107, the sport they are participating in, etc. The content of the guide may be based on research in child development, coaching, parenting and sports psychology. The guide may prepare both the parent 109 and athlete 107 for their first practice. The guide may also address the specific development needs of each child, and address possible parental questions and concerns. “Parent Guides” may generally include a basic summary of the sport to be played, the rules of the sport, preparations helpful for young players, and the parent's role in the game. The use of the “Parent Guide” by parents 109 may be tracked. A timestamp may be generated each time parent 109 accesses a page within the “Parent Guide.” If the interactive community network for youth athletics system 100 detects that a parent 109 has not completed viewing all pages of the “Parent Guide” and has not viewed pages any within a pre-defined time frame, a reminder may be issued to parent 109 to complete the “Parent Guide.” This may ensure that the parent 109 has been appropriately educated with respect to using the interactive community network for youth athletics system 100, maintaining appropriate behavior at events, interacting beneficially with coaches 110, and implementing good methods to develop athletes 107.

The “Meet the Player” and “Meet the Coach” web pages may document pertinent information received during the initial enrollment process. This may advantageously give each party better perspective on the character and experience of the person they are dealing with. For example, the “Meet the Coach” web page may display basic contact information, certification information, coaching experience, sports experience and educational information. The “Meet the Player” webpage may be generated from information received during initial registration, the “Athlete Accelerator,” “Athlete Medical Questionnaire” and “Athlete Accelerator Goal Selector” (as described above), and display contact information, sports experience, etc. These pages may be dynamically generated from information received by the interactive community network for youth athletics system 100 (as described above).

In step 217, at the end of the season, an “Enrichment Survey” may be issued to parents 109 to enable league organizations 108 to determine satisfaction level of parents 109. The “Enrichment Survey” may include generalized questions directed towards the quality the interactive community network for youth athletics system 100 itself, inclusive of the associated league organization 108. Questions may be presented on the product in terms of clarity, ease of use, satisfaction on the main components of the preceding steps (such as the “Athlete Accelerator,” “Parent Guide,” etc. Additionally, more generalized questions may be issued regarding satisfaction on the overall process methodology, ease of communication, cost, and satisfaction regarding the overall outcome for athlete 107. Parents 109 may answer the questions by, for example, selecting one of a series of choices on a scale from one to ten. Of course, other methods may be utilized as appropriate for the questions presented.

In step 218, at the end of the season, an “Athlete Review” may be issued to the parent 109. The “Athlete Review” may be completed by the coach 110 and assess, generally, how the athlete 107 progressed during the season. This performance summary may be organized against prior information received by the interactive community network for youth athletics system 100 previously, such as the pre-season “Athlete Accelerator Goal Selector” and mid-season “Athlete Goal Debriefing Form(s)” (described above). For example, the “Athlete Review” may be segregated into “sport specific goals,” “core development tenets,” and “team goals.” Within each section, the previously selected goals for the season may be listed, with a grade next to each indicating how the athlete 107 progressed with respect to that goal. One or more comment fields may be provided so coach 110 may include more personal or detailed messages on specific aspects of the performance of athlete 107.

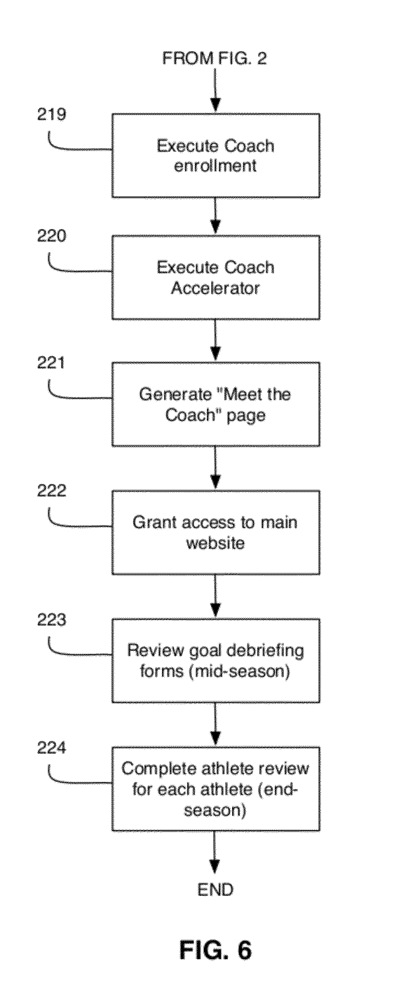

FIG. 6 is a flow chart representing a continuing sequence of steps for implementing the illustrative interactive community network for youth athletics 100. In step 219, the illustrative interactive community network for youth athletics 100 may execute enrollment for a coach 110. As with the parent enrollment described above, coaches 110 may be prompted to create a user account, including, for example, a selected user name and password that may govern the access and usage of the interactive community network for youth athletics system 100. Once the coach 110 has completed entering the information necessary to create a basic account, the information may be encapsulated and transmitted over network 105 to the interactive community network for youth athletics system 100, where it may then be stored in database 103.

The coach 110 may then be directed to an enrollment page, where he may enter required enrollment information. This information may his name, gender, phone number, and e-mail address. If an assistant coach is being utilized, the assistant's name, phone number and e-mail address may also be required. Biographical information may also be requested, such as current or upcoming coaching certifications, education history, coaching experience, sports experience, occupation, interests and hobbies, etc.

In step 220, the interactive community network for youth athletics system 100 may execute the “Coach Accelerator” for coach 110. The “Coach Accelerator” may generally mirror the “Athlete Accelerator,” but may be directed towards coaching guidance and improvement rather than athletic guidance and improvement. Therefore, as with the “Athlete Accelerator,” the “Coach Accelerator” may include three main segments. The first segment may present assessment questions regarding the core development factors and sport specific factors of athlete coaching. Questions may be directed to determine the disposition of the coach 110 towards core coaching development factors and sport specific factors for coaching. Each question preferably targets at least one of these core developmental factors or one sport specific factor. In the second segment, guided educational material and other useful aids may be dynamically generated from (at least in part) information obtained during this initial segment of the “Coach Accelerator.” The third segment of the “Coach Accelerator” may be directed towards coaching goal selection, goal attainment and goal review. Goals may be selected and broken down into subcomponents to allow for directed improvement of specific coaching areas. Subsequently, periodic “Coach Debriefing Forms” may be completed by coach 110 to assess the progress coach 110 has made within each goal category.

In step 221, a “Meet the Coach” web page may be generated dynamically by the interactive community network for youth athletics system 100 from information obtained during the coach enrollment and “Coach Accelerator.” The “Meet the Coach” web page may be populated with general information, including the name, gender, phone number, e-mail address, coaching experience duration and occupation of coach 110. It may also include his biography, coaching experience, post/present sport experience and educational history. Once the page is populated, a notification may be issued to all relevant registered parents 109 that the “Meet the Coach” web page is available for viewing.

In step 222, coach 110 may be granted access to the main interactive community network for youth athletics system 100, because enrollment has been completed. Coach 110 may receive access to the Seasonal Team Management Tools and the “Coach Guide.”

The Seasonal Team Management Tools may provide the coach 110 with three types of functionality. First, the Seasonal Team Management Tools may provide access to the basic products and services of the main interactive community network for youth athletics system 100, such as the “Coach Guide,” “Coach Accelerator,” etc. Second, the Seasonal Team Management Tools may allow coach 110 to track the seasonal products for participants in his care, such as athletes 107 and parents 109. For example, the Seasonal Team Management Tools may include a pre-season checklist. The pre-season checklist may comprise a list of all parents 109 and athletes 107 participating in the sport activity coach 110 is coaching. Therefore, the pre-season checklist may be utilized to ensure, for example, that all participants have completed the registration and enrollment process (as described above). Completion may be indicated to the coach 110, for example, via a completion symbol awarded upon completion of enrollment, or alternatively, a percentage indicating what percentage of the enrollment process has been completed. If an athlete 107 or parent 109 has not completed the registration and enrollment process, then the Team Management Tools may allow the coach 110 to manually send out reminder notices (through e-mail, for example) indicating to the recipients that registration and enrollment completion is still outstanding.

Third, the Seasonal Team Management Tools may allow tracking of individual and aggregate results for the selected specific goals of the respective athletes 107 on the roster of coach 110. This may provide a unique dynamic vantage point from which to analyze the progress of both individual athletes 107 and the aggregate team with respect to the goals they have selected for themselves through the “Athlete Accelerator Goal Selector.” This may be useful for assessing areas where the entire team needs improvement. For example, the Seasonal Team Management Tools may indicate to a coach 110 that within his team, only 30% of athletes 107 feel confident in the sport specific goal of catching a ball with the dominant hand while running This may be beneficial as the coach 110 may then make adjustments to the practice schedule to benefit a large number of athletes 107.

The Team Management Tools may also include other features. For example, the tools may allow the coach 110 to view the individual “Meet the Players” pages for each athlete 107, and/or a corresponding parent 109 information webpage. They may also provide a channel through which coach 110 may track parent 109 completion of the “Parent Guide.” For example, a completion symbol or percentage may be utilized (as above) to indicate to coach 110 what portion of the “Parent Guide” has been completed by each individual parent 109. If a parent 109 has failed to complete the “Parent Guide,” Team Management Tools may allow the coach 110 to manually send out reminder notices urging parents 109 to complete the “Parent Guide.” Team Management Tools may similarly centralize other core coach functions for coaches 110. For example, the “Athlete Goal Debrief Forms” may be made available to the coaches 110 (as described further below). The end of season “Athlete Reviews” may be completed through the Team Management Tools. This information may then be compiled and presented for each athlete 107 and parent 109 for review.

The “Coach Guide” may include customized information based on research in child development, coaching, parenting and sport psychology. The guide may prepare both the coach 110 for both his first practice, and the season in general. The guide may explain appropriate coaching techniques with respect to decision-making, athlete evaluation, process creation and the establishment of goals for both the team as a whole, and for individual athletes 107. Unique “Coach Guides” may also be created for each sporting event. “Coach Guides” may include, for example, a summary of the sport to be played, the rules of the sport, preparations helpful for young or new players, effective coaching techniques specific to the sport, etc. The use of the “Coach Guide” by coaches 110 may be tracked, so that a timestamp is generated each time coach 110 accesses a page within the “Coach Guide.” If the interactive community network for youth athletics system 100 detects that a coach 110 has not completed viewing all pages of the “Coach Guide” and has not viewed pages any within a pre-defined time frame, a reminder may be issued to coach 110 to complete the “Coach Guide.” This may ensure that the coaches 110 have been appropriately educated with respect to using the interactive community network for youth athletics system 100, maintaining appropriate behavior at events, interacting beneficially with parents 109, and implementing good methods to coach athletes 107. This reminder may be issued by a Program Director who is overseeing the operation of the League Organization 108 by utilizing an Overview Tool (as described further below).

In step 223, during the mid-season, coaches 110 may review “Athlete Goal Debriefing Forms” that (as described above) have been completed by parents 109 and athletes 107. This may advantageously provide coaches 110 with feedback on areas parents 109 and athletes 107 find lacking in the progress of athletes 107. Coaches 110 may then alter their coaching methodology to better address the deficiencies parents 109 and athletes 107 have highlighted through the “Athlete Goal Debriefing Forms,” while maintaining those areas that parents 109 find to be strong.

In step 224, during the end of the season, coaches 110 may complete an “Athlete Review” for each athlete 107 he has coached. As described above, the “Athlete Review” may be completed by coaches 110 and assess, generally, how each individual athlete 107 performed during the season. This performance summary may be organized against prior information received by the interactive community network for youth athletics system 100, such as the pre-season “Athlete Accelerator” and “Athlete Goal Debriefing Forms.” Coaches 110 may complete these reviews for the benefit of parents 109 and athletes 107. Once these reviews are complete, notifications may be sent to parents 109 that the “Athlete Reviews” are available for viewing.

The interactive community network for youth athletics system 100 may also include an Overview Tool allowing a Sports League Program Director to oversee all seasonal products and services for participants, including coaches 110, athletes 107 and parents 109. The Program Director may enforce tracking and accountability through the Overview Tool, allowing powerful management of individuals within an Athletic League. The Overview Tool may also provide a hierarchal overview of the entire Athletic League, based on the information participants have entered into the system (as described above).

This hierarchal overview may be organized by division of the overall program of the League Organization 108 into distinct levels. These levels may correspond to the different experiences/age groups for sports activities. For example, baseball may be divided into “tee-ball,” “minor league,” “junior league,” “senior league,” and finally, “big league.” Alternatively, broader classifications may encompass more than one sport simultaneously, and use age as the determining factor. Any classification may be utilized as appropriate. The classifications may be further divided into subgroups. For example, within the “tea-ball” classification, several teams may be displayed corresponding to the teams partaking in the “tee-ball” program hosted by League Organization 108. Within each team may be a list of participants, such as the coaches 110, parents 109 and athletes 107.

The hierarchal overview of the entire League Organization 108 is also scalable from an overall League-based view down to the details of individual participants. A Program Director may then select each distinct level of the League Organization 108 for viewing, all the way down to the individual details of a coach 110, parent 109 or athlete 107, giving the Program Director an unprecedented breadth of information. The Program Director may thus implement broad-level strategies or policy changes designed to help the greater number of participants meet their respective goals, with which it is now possible for the Program Director to be intimately familiar.

The Program Director may also aid with small-scale management. As with the “Team Management Tool provided to coaches 110, one or more completion symbols or percentages may indicate, at each detail level, whether the participants within that subdivision have completed registration, enrollment, “Parent Guides,” “Coach Guides,” “Athlete Accelerator,” and “Athlete Goal Debriefing Forms,” etc. The Program Director may utilize the Overview Tool to send reminder notices to individuals (or to categories of individuals) to finish any incomplete function or segment of the interactive community network for youth athletics system 100. The Overview Tool, combined with the participant information collection and dynamic generation of educational material (as described above), provides the Program Director with a powerful view of the status of the Athletic League and its various participants, allowing superior management of the League as compared to traditional solutions.

The interactive community network for youth athletics system 100 may be implemented utilizing one or more computing systems of varying configurations. For instance, the computing systems may be combined as a single computing system. Each computing system preferably includes computing components for executing computer program instructions and processes. These components may include a central processing unit (CPU) 111, memory 112, input/output (I/O) devices 113, and a network interface 114.

As described above, the CPU 111 processes and executes computer program instructions. Random access memory (RAM) 112 and/or fast access cache memory preferably provides fast data supply to CPU 111. Long-term storage may be provided as a more permanent form of computer memory, and may be, for example, a hard disk, optical disk, flash memory, solid-state memory, tape, or any other type of memory. The I/O device(s) 113 permit human interaction with the computer system, such as (but not limited to) a mouse, keyboard and computer display. I/O device(s) 113 may also include other interactive devices, such as (but not limited to) touch screens, digital stylus, voice input/output, etc.

The network interface device 114 may provide the computing system with access to a network, which may be a wireless or wired connection. The network may be, for example, the Internet, a corporate intranet, or any other computer network through which the computing system may connect to or otherwise communicate with other computers and any databases representing other computerized systems for specialized information that may be necessary for implementation of the interactive youth athletics network system 100.

Software process or processes and executables on the computing system may be used to provide human interfaces (such as a graphical user interface), and to store and initiate computer program instructions used to process and analyze data. Computer program code for carrying out operations described herein may be written in any combination of one or more programming languages, including an object oriented programming language such as Java, C++, C# or the like and conventional procedural programming languages, such as the “C” programming language or similar programming languages. The program code may execute entirely on the computing system, partly on the computing system, as a stand-alone software package, partly on the computing system and partly on a remote computer or server, or entirely on a remote computer or server.

This application was described above with reference to flow chart illustrations and/or block diagrams of methods, apparatus (systems) and computer program products according to one or more embodiments. It is understood that some or all of the blocks of the flow chart illustrations and/or block diagrams, and combinations of blocks in the flow chart illustrations and/or block diagrams, can be implemented by computer program instructions. The computer program instructions may also be loaded onto the computing system to cause a series of operational steps to be performed on the computer to produce a computer implemented process such that the instructions that execute on the computer provide processes for implementing the functions/acts specified in the flowchart and/or block diagram block(s). These computer program instructions may be provided to the CPU 111 of the computing system such that the instructions, which execute via the CPU 111 of the computing system, create means for implementing the functions/acts specified in the flowchart and/or block diagram block(s).

These computer program instructions may also be stored in a computer-readable medium that can direct the computing system to function in a particular manner, such that the instructions stored in the computer-readable medium implement the function/act specified in the flowchart and/or block diagram block or blocks. Any combination of one or more computer usable or computer readable medium(s) may be utilized. The computer-usable or computer-readable medium may be, for example (but not limited to), an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory, a read-only memory, an erasable programmable read-only memory (e.g., EPROM or Flash memory), an optical fiber, a portable compact disc read-only memory, an optical storage device, a transmission media such as those supporting the Internet or an intranet, or a magnetic storage device. Any medium suitable for electronically capturing, compiling, interpreting, or otherwise processing in a suitable manner, if necessary, and storing into computer memory may be used. In the context of this disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in base band or as part of a carrier wave. The computer usable program code may be transmitted using any appropriate medium, including (but not limited to) wireless, wire line, optical fiber cable, RF, etc.

Having described and illustrated the principles of this application by reference to one or more embodiments, it should be apparent that the embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A computer-implemented system for implementing an interactive community network for youth athletics, comprising:
at least one programmable processor;
computer storage accessible by the processor, wherein the programmable processor is connected to the computer storage to receive information from the computer storage, wherein the computer storage comprises
a series of educational messages, each educational message being associated with at least one youth athletics core development factor and a threshold range of numerical scores;
a series of questions about an athlete, each question corresponding to a youth athletics core development factor;
selectable answers to each question, each selectable answer corresponding to a numerical score; and
program instructions which, when executed by the programmable processor, cause the programmable processor to:
issue the series of questions about the athlete to a user,
receive an answer selection for each question from the user,
aggregate the numerical scores according to each youth athletics core development factor, and
generate a personalized educational message for display based on a result of the aggregation by selecting at least one of the educational messages in the series of educational messages when the aggregated numerical score for a corresponding youth athletics core development factor associated with the at least one of the educational messages falls within the threshold range associated with the at least one of the educational messages.

2. The system of claim 1, the computer storage further comprising:
additional educational messages, each additional educational message being associated with one sport specific factor and one threshold range of numerical scores;
wherein the program instructions, when executed by the programmable processor, cause the programmable processor to:
issue to the user, using a computer processor, a series of additional questions about an athlete, each additional question corresponding to one sport specific factor,
provide selectable answers to each additional question, each selectable answer corresponding to a numerical score,
receive an answer selection for each additional question from the user, and
aggregate, using the computer processor, the numerical scores according to each sport specific factor; and
wherein the personalized educational message generated for display includes at least one of the additional educational messages when the aggregated numerical score for a corresponding sport specific factor associated with the at least one of the additional educational messages falls within the threshold range associated with the at least one of the additional educational messages.

3. The system of claim 1, the computer storage further comprising:
a series of athlete goal oriented educational messages, each educational message being associated with at least one athlete goal selection; and
wherein the program instructions, when executed by the programmable processor, cause the programmable processor to:
provide selectable athlete goals to the user,
receive an athlete goal selection from the user, and
select at least one of the series of athlete goal oriented educational messages for display based on the received athlete goal selection.

4. The system of claim 3, wherein the program instructions, when executed by the programmable processor, cause the programmable processor to:
automatically generate an informational summary, using the received answer selections and the athlete goal selection, on the athlete for whom the answer selections and the athlete goal selection were provided.

5. The system of claim 4, wherein the program instructions, when executed by the programmable processor, cause the programmable processor to:
generate a goal debriefing form based on the received athlete goal selection, the goal debriefing form including a list of the received athlete goal selection;
issue the goal debriefing form to the user; and
receive a goal debriefing answer from the user grading the athlete's progress towards completion of the athlete goal.

6. The system of claim 5, wherein program instructions, when executed by the programmable processor, cause the programmable processor to:
automatically issue the goal debriefing form to the user periodically through the course of an athletic season.

7. The system of claim 1, wherein the program instructions, when executed by the programmable processor, cause the programmable processor to:
issue an enrichment survey to the user at the end of an athletic season; and
receive enrichment survey answers from the user indicating the user's satisfaction with the interactive community network for youth athletics.

8. The system of claim 5, wherein the program instructions, when executed by the programmable processor, cause the programmable processor to:
generate an athlete review using the goal debriefing answer, the received answer selections, the at least one athlete goal selection, and the answer selection;
issue the athlete review to a coach of the athlete;
receive a completed athlete review from the coach; and
issue the completed athlete review to the user.

9. The system of claim 1, wherein the core development factors are selected from the group consisting of goal setting, temperament, emotional management, attention and self-belief.

10. The system of claim 2, wherein the sport specific factors are selected from the group consisting of at least one of physical and mental actions or attributes of the athlete that contribute to success in a sport.

11. A computer-implemented method for implementing an interactive community network for youth athletics, comprising:
maintaining, in computer storage, a series of educational messages, each educational message being associated with at least one youth athletics core development factor and a threshold range of numerical scores;
issuing to a user, using a computer processor, a series of questions about an athlete, each question corresponding to a youth athletics core development factor;
providing selectable answers to each question, each selectable answer corresponding to a numerical score;
receiving an answer selection for each question from the user;
aggregating, using the computer processor, the numerical scores according to each youth athletics core development factor; and
generating a personalized educational message for display based on a result of the aggregation by selecting at least one educational message in the series of educational messages when the aggregated numerical score for a corresponding youth athletics core development factor associated with the at least one educational message falls within the threshold range associated with the at least one educational message.

12. The method of claim 11, further comprising:
maintaining, in computer storage, additional educational messages, each additional educational message being associated with one sport specific factor and one threshold range of numerical scores;
issuing to the user, using a computer processor, a series of additional questions about an athlete, each additional question corresponding to one sport specific factor;
providing selectable answers to each additional question, each selectable answer corresponding to a numerical score;
receiving an answer selection for each additional question from the user;
aggregating, using the computer processor, the numerical scores according to each sport specific factor; and
wherein the personalized educational message generated for display includes at least one of the additional educational messages when the aggregated numerical score for a corresponding sport specific factor associated with the at least one of the additional educational messages falls within the threshold range associated with the at least one of the additional educational messages.

13. The method of claim 11, further comprising:
maintaining, using the computer storage, in addition to the series of educational messages, a series of athlete goal oriented educational messages, each educational message being associated with an athlete goal selection;
providing selectable athlete goals to the user;
receiving an athlete goal selection from the user;
selecting, using the computer processor, one of the series of athlete goal oriented educational messages for display based on the received athlete goal selection.

14. The method of claim 13, further comprising:
using the received answer selections and the athlete goal selection to automatically generate, using the computer processor, an informational summary on the athlete for whom the answer selections and the athlete goal selection were provided.

15. The method of claim 14, further comprising:
generating, using the computer processor, a goal debriefing form based on the received athlete goal selection, the goal debriefing form including a list of the received athlete goal selection;
issuing the goal debriefing form to the user; and
receiving a goal debriefing answer from the user grading the athlete's progress towards completion of athlete goals identified in the received athlete goal selection.

16. The method of claim 15, further comprising:
automatically issuing the goal debriefing form to the user periodically through the course of an athletic season.

17. The method of claim 11, further comprising:
automatically issuing, using the computer processor, an enrichment survey to the user at the end of an athletic season; and
receiving enrichment survey answers from the user indicating the user's satisfaction with the interactive community network for youth athletics.

18. The method of Claim 15, further comprising:
automatically generating, using the computer processor, an athlete review using the goal debriefing answer, the received answer selections, the athlete goal selection, and the answer selection;
issuing the athlete review to a coach of the athlete;
receiving a completed athlete review from the coach; and
issuing the completed athlete review to the user.

19. The method of claim 11, wherein the core development factors are selected from the group consisting of goal setting, temperament, emotional management, attention and self-belief.

20. The method of claim 12, wherein the sport specific factors are selected from the group consisting of at least one of physical and mental actions or attributes of the athlete that contribute to success in a sport.
